(19) United States
(12) Patent Application Publication
(10) Pub. No.: US 2010/0259611 A1
(43) Pub. Date: Oct. 14, 2010

(54) System, method, and device for controlled user tracking

(76) Inventors: Abtin Keshavarzian, Palo Alto, CA (US); David Krum, Mountain View, CA (US); Dhananjay Lal, Pittsburgh, PA (US); Bhaskar Srinivasan, Menlo Park, CA (US)

Correspondence Address: KENYON & KENYON LLP, ONE BROADWAY, NEW YORK, NY, 10004, US

(21) Appl. No.: 11/521,279

(22) Filed: Sep. 14, 2006

(51) Int. Cl. G08B 1/08; H04N 7/18

(52) U.S. Cl. 348/143; 340/539.13; 348/E07.085

(57) ABSTRACT

In a system and method for controlled user tracking, a mobile device is provided for transmitting an identification signal, and a reader unit, which is statically located at a location, is provided for receiving the identification signal and transmitting to a surveillance control unit, in response to receipt of the identification signal, either the received identification signal or another signal that identifies the mobile device, for logging by the surveillance control unit of a presence of the mobile device at the location, where the mobile device and/or the reader unit is configured to transmit at least one surveillance control message for control of surveillance at the location.

### FIELD OF THE INVENTION

The present invention relates to a network and system that includes tracking equipment and user assigned mobile badges, which, for example, includes radio frequency identification (RFID) tags, that communicate with stationary readers, such as RFID readers, and with network nodes. The present invention further relates to a method for implementing the network and system for controlled tracking, and to devices implemented in the network and system for controlled tracking.

### BACKGROUND INFORMATION

A real space collaborative workspace may be an area in which a group of people gather in furtherance of a common goal. The workspace can be, for example, a single room, a building, or even a plurality of separate real space areas virtually connected. It may be desirable to track those who are present in such a workspace for security and/or productivity reasons. For example, tracking may help ensure that only authorized personnel access the workspace or sub-spaces of the workspace. Tracking may also help provide information regarding who is a likely source of information regarding various topics and events concerning that which takes place within the workspace. For example, if information is sought regarding an experiment conducted at a particular sub-space of the workspace, the tracking information can indicate those who were present at the particular sub-space at that time, i.e., those who may be most likely to provide useful input regarding the experiment.

Components of a system for such tracking in a collaborative workspace may be surveillance equipment and identification badges in communication with readers. Such surveillance and tracking may be imposed upon personnel of the workspace and may even be embraced by the personnel since it may aid in the furtherance of goals in which the personnel endeavor, both with respect to security and providing useful information as discussed above. Nevertheless, it may occur that a participant of the workspace desires at least temporary disablement of the tracking of the participant's presence and/or activities within the workspace or sub-spaces thereof.

Accordingly, there is a need for a system and method that provides for user controlled tracking in real space collaborative workspaces.

### SUMMARY

According to an example embodiment of the present invention, a surveillance system may provide: a surveillance control unit; a mobile unit for transmitting an identification signal; and a first reader unit, statically positioned at a first location, for receiving the identification signal from the mobile unit and for transmitting, in response to receipt of the identification signal, the identification signal or another signal that identifies the mobile unit to the surveillance control unit for logging by the surveillance control unit of a presence of the mobile unit at the first location. This signal transmitted to the surveillance control unit is also referred to herein as a logging signal. The mobile unit and/or the first reader unit may be configured to transmit at least one surveillance control message for control of surveillance at the first location.

The surveillance system may further provide surveillance equipment. The at least one surveillance control message may include a first instruction type for preventing the logging of the mobile unit's presence and/or a second instruction type for preventing recording by particular ones of the surveillance equipment that have an association with the first location.

The surveillance control unit may store a first log entry indicating the presence of the mobile unit at the first location. Whether the first log entry is stored may be conditional upon receiving the logging signal without receiving an instruction of the first instruction type that is associated with the logging signal. If the surveillance equipment that has the association with the first location is on when an instruction of the second instruction type is received by the surveillance control unit, the surveillance control unit may turn off the surveillance equipment having the association with the first location in response to receipt of the instruction of the second instruction type.

The mobile unit may transmit the instruction of the first instruction type to the first reader unit. The first reader unit may forward the instruction of the first instruction type to the surveillance control unit. In response to the receipt of the instruction of the first instruction type, the surveillance control unit may store a second log entry of the presence of the mobile unit at the first location. The second log entry may be a temporary one. In one example embodiment, the surveillance control unit may initially enter the first log entry, and, for storing the second log entry, the surveillance control unit may mark the first log entry as temporary, so that the first log entry is converted to the second entry. In response to the instruction of the second instruction type, the surveillance control unit associates the instruction of the second instruction type with the first location based on the second log entry.

In one example embodiment, the mobile unit may transmit the instruction of the first instruction type to the surveillance control unit. The surveillance control unit may associate the instruction of the first instruction type with the first log entry by determining that the mobile unit identified in the first log entry is the mobile unit from which the instruction of the first instruction type was received. In response to receipt of the instruction of the first instruction type, the surveillance control unit may discontinue storing the first log entry or refrain from entering the first log entry, e.g., if not already entered.

In response to a lapse, from the turning off of the surveillance equipment that has the association with the first location, of either a predetermined amount of time or an amount of time specified in the instruction of the second instruction type, the surveillance control unit may turn on the surveillance equipment that has the association with the first location.

In one example embodiment, subsequent to turning off the surveillance equipment that has the association with the first location, the surveillance control unit may turn the surveillance equipment that has the association with the first location back on in response to a signal that identifies the mobile unit and that is received from a second reader unit statically positioned at a second location if both (a) the surveillance equipment that has the association with the first location does not have an equivalent association with the second location and (b) the association with the first location does not define an area including the second location.

In response to a lapse, from the turning off of the surveillance equipment that has the association with the first location, of a predetermined amount of time or an amount of time specified in the instruction of the second instruction type, the surveillance control unit may transmit to the mobile unit a message as a reminder to turn on the surveillance equipment that has the association with the first location.

If the surveillance equipment that has the association with the first location is off when the instruction of the second instruction type is received by the surveillance control unit, the surveillance control unit may store the instruction of the second instruction type in an instruction queue for later execution. The instruction of the second instruction type may be removed from the queue in response to execution of the instruction of the second instruction type, receipt of a trigger originating at the mobile unit for turning on the surveillance equipment that has the association with the first location, and/or a lapse, from a time of receipt of the instruction of the second instruction type by the surveillance control unit, of a predetermined amount of time or an amount of time specified in the instruction of the second instruction type.

In response to a trigger for turning on the surveillance equipment that has the association with the first location, if any instruction of the second instruction type that is associated with the surveillance equipment that has the association with the first location is pending, the surveillance control unit may defer turning on the surveillance equipment that has the association with the first location until after no instruction of the second instruction type that is associated with the surveillance equipment remains pending. A pending instruction may be one that is either queued or being executed.

The mobile unit may transmit the instruction of the first instruction type to the first reader unit. In response to the instruction of the first instruction type, the first reader unit may refrain from transmitting the logging signal to the surveillance control unit.

The first reader unit may include an input device for receiving input of the at least one surveillance control message. The first reader unit may forward the at least one surveillance control message or a modification of the at least one surveillance control message input via the input device to the surveillance control unit. The at least one surveillance control message may be associated with the mobile unit based on an identification input that is input into the input device, the identification signal, or the other signal that identifies the mobile unit.

For example, the first reader unit may associate the at least one surveillance control message with the mobile unit if the identification signal received by the first reader unit from the mobile unit is (a) an only identification signal received by the first reader unit prior to receiving the input of the at least one surveillance control message or (b) a last one of a plurality of identification signals that is received by the first reader unit prior to receiving the input of the at least one surveillance control message.

In another exemplary embodiment, the surveillance control unit may receive the at least one surveillance control message and associate it with the mobile unit if the logging signal received by the surveillance control unit from the first reader unit is (a) the only logging signal received by the surveillance control unit from the first reader unit or (b) a last one of a plurality of logging signals received by the surveillance control unit from the first reader unit prior to receiving the at least one surveillance control message.

The surveillance equipment that has the association with the first location may include a video and/or audio surveillance equipment. The video and/or surveillance equipment may include a video camera.

The mobile unit may include an RFID tag for transmitting the identification signal, and the first reader unit may include an RFID reader.

According to an example embodiment of the present invention, a surveillance method may provide: transmitting an identification signal by a mobile unit to a reader unit statically positioned at a location for indicating a presence of the mobile unit at the location; and transmitting at least one surveillance control message by the mobile unit or the statically positioned reader unit to a surveillance control unit for preventing a logging by the surveillance control unit of the presence of the mobile unit at the location and/or preventing recording by surveillance equipment having an association with the location.

The method may further provide: for the logging, in response to receiving the identification signal by the reader unit, transmitting, by the reader unit, a logging signal, which may be the identification signal or another signal that identifies the mobile unit, to the surveillance control unit; and associating, by the surveillance control unit, the at least one surveillance control message with the logging signal by determining that: (a) the mobile unit identified in the logging signal is the mobile unit from which the at least one surveillance control message is received; or (b) the logging signal and the at least one surveillance control message are received from the same reader unit, and the logging signal is either (i) an only logging signal received from the reader unit prior to receiving the at least one surveillance control message, or (ii) a last one of a plurality of logging signals received from the reader unit prior to the surveillance control unit receiving the at least one surveillance control message.

According to an example embodiment of the present invention, a mobile identification device may provide: an identification signal transmitter for transmitting an identification signal to a reader unit statically located at a location; an input device for receiving input of at least one surveillance control message; and a message transmitter for transmitting the at least one surveillance control message to a surveillance control unit for instructing the surveillance control unit to (a) refrain from maintaining a log entry indicating a presence of the mobile identification device at the location and/or (b) turn off surveillance equipment associated with the location.

The identification signal transmitter may be an RFID tag.

The identification signal transmitter and the message transmitter may transmit data at different frequencies.

The identification signal transmitter may transmit the identification signal at an ultra high frequency.

The message transmitter may transmit the at least one surveillance control message at a lower frequency than the ultra high frequency.

The at least one surveillance control message may be transmitted for association by the surveillance control unit with a logging signal based on the identification signal after receipt of the logging signal from the reader unit.

The at least one surveillance control message may be associated with the location based on the association of the at least one surveillance control message with the logging signal.

### BRIEF DESCRIPTION OF THE DRAWINGS

FIG. 1 is a block diagram that illustrates example components of a workspace and a data flow therebetween, according to an example embodiment of the present invention.

FIG. 2 is a diagram that illustrates example components of a workspace having an entrance/exit sub-space, according to an example embodiment of the present invention.

FIG. 3 is a cross-functional flowchart that illustrates an example method for controlling logging and surveillance in a workspace via an RFID reader, according to an example embodiment of the present invention.

FIG. 4 is a cross-functional flowchart that illustrates an example method for controlling logging and surveillance in a workspace, according to an alternative example embodiment of the present invention.

FIG. 5 is a diagram and flowchart that illustrates an example instructions-queuing-scheme and method that may be performed for controlling surveillance equipment, according to an example embodiment of the present invention.

### DETAILED DESCRIPTION

Exemplary embodiments of the present invention relate to a tracking system and method that may provide user control of tracking in a real space collaborative workspace. The system may include user assigned mobile badges for communication with stationary readers. The badges and/or the readers may include one or more components for indicating a user's tracking preference. Examples of such components may be buttons, switches, or a keypad. The user may indicate a tracking preference regarding operation of surveillance equipment, such as video/audio equipment, and/or regarding a tracking log compiled based on user identifications associated with tags read by the readers.

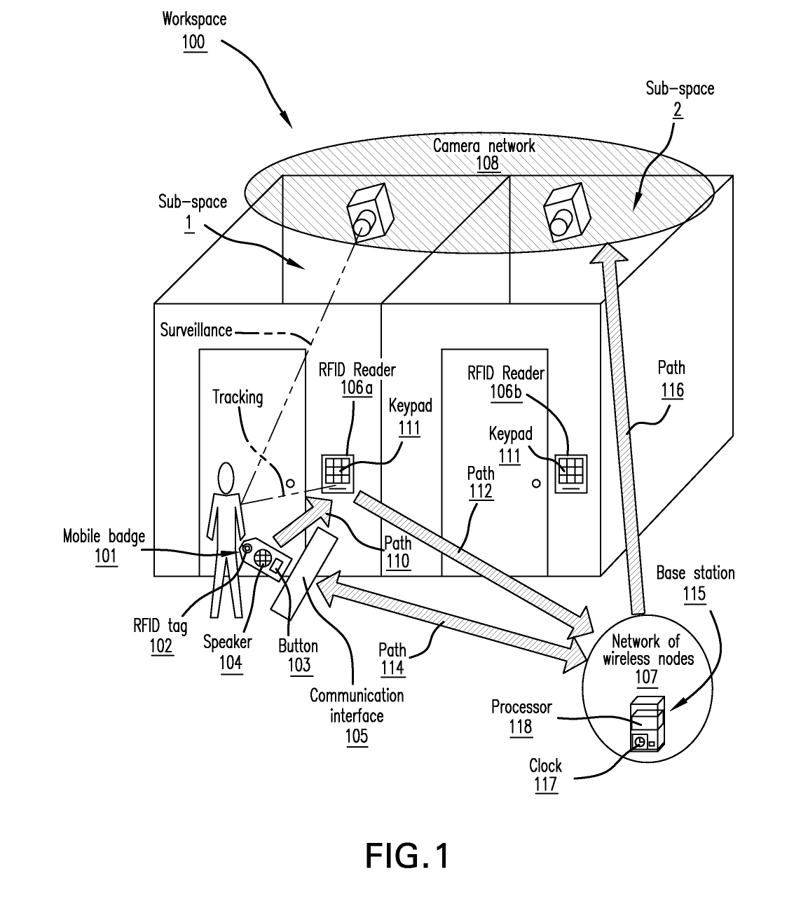

FIG. 1 is a block diagram that illustrates components of an exemplary embodiment of the present invention. A mobile badge 101 may be assigned to and associated with a user. The mobile badge 101 may include a device for transmitting an identification signal, such as an RFID tag 102. The RFID tag 102 may be any suitably appropriate RFID tag, such as, for example, a passive, semi-passive, or active RFID tag. The RFID tag may be a low powered radio frequency (RF) wireless node embedded on the mobile user. In an exemplary embodiment of the present invention, the badge 101 may also include one or more components for user input and for output. For example, the badge 101 may include one or more buttons 103 for input and a speaker 104 for output. Other exemplary input/output components may include a switch, a keypad, and/or one or more light emitting diodes (LEDs). Any suitably appropriate input and output components may be used. The badge 101 may be a key-fob-like device or may be a high-end device, such as a personal digital assistant (PDA). The badge 101 may include an interactive communication interface 105 for wireless communication with a network of wireless nodes 107.

A plurality of devices for receiving the identifying signals, such as RFID readers 106, may be distributed throughout a workspace 100. The RFID readers 106 may be low powered RF wireless nodes embedded in the environment for reading the signals. Each RFID reader 106 may be associated with a different corresponding sub-space of the workspace 100. For example, in FIG. 1, RFID reader 106a is associated with sub-space 1 of workspace 100 and RFID reader 106b is associated with sub-space 2 of workspace 100. The RFID readers 106 may detect the presence of the mobile badge 101. A signal of the RFID tag 102 may travel along communication path 110 to an RFID reader 106 that is within a communication range of the RFID tag 102 for detection of the presence of the mobile badge 101 by the RFID reader 106. The RFID tags 102 may be configured to transmit at high frequencies, e.g., ultra high frequencies (UHF), so that their signals may be detected by only an RFID reader 106 that is nearby. UHF may be used to limit the communication range between an RFID tag 102 and an RFID reader 106. For example, in FIG. 1, the signal output by the RFID tag 102 may be received by the RFID reader 106a but not by the RFID reader 106b, since of the two readers 106, only the RFID reader 106a is in a communication range of the RFID tag 102. (It is not required, however, to use UHF in order to so limit the communication range. For example, the extent of the communication range may be varied by varying the extent of each device's power. UHF may used for convenience or to comply with a prevailing standard even if not required for limiting a communication range for communication between an RFID tag 102 and a reader 106.)

Aside from reading short range signals of RFID tags 102, the RFID readers 106 may include a transmitter for transmitting longer range signals to a base station 115 that tracks the users' movements, e.g., by entering entries in a log, and that controls surveillance equipment. The different ranges of the different transmitters may be provided for by using different frequencies, e.g., a lower frequency for transmitting the longer range signals, or by varying other configurations, e.g., providing varying levels of power to the different transmitters. For example, by varying the power provided to different transmitters, a transmitter transmitting at a first frequency may have a larger communication range than even another transmitter transmitting at a lower second frequency. (It is noted that the different transmitters may transmit at different frequencies for reasons other than varying their respective communication ranges.) The base station 115 may include a processor 118 to process logging and equipment inhibition instructions for determining whether to log a user's presence at a location and/or to turn off surveillance equipment, and/or for determining whether to turn on surveillance equipment. For example, an RFID reader 106 may directly communicate with the base station 115 or may communicate with a network of wireless nodes 107, including the base station 115, along communication path 112. Accordingly, the signal transmitted by the RFID reader 106 may be transmitted to the base station 115 either directly or through multiple network node hops. In response to the signal, the base station 115 may log the entrance of a user identified by the signal into the sub-space associated with the transmitting RFID reader 106. For example, the base station 115 may include a mapping of RFID readers to sub-spaces, and may log the user's presence at the sub-space associated with the transmitting RFID reader 106.

In an example embodiment of the present invention, a user may transmit to an RFID reader 106 an instruction along communication path 110 to refrain from logging the user's presence in the sub-space with which the RFID reader 106 is associated. For example, the instruction may be entered by pressing a button 103 of the user's badge 101. Alternatively or in addition, an RFID reader 106 may include an input device, for example, that has buttons, e.g., a keypad 111, for input of instructions by the users. In response to receiving the instruction, the RFID reader 106 may refrain from transmitting a signal to the base station 115 indicating the user's presence at the location of the RFID reader 106. Alternatively, the RFID reader 106 may transmit, along communication path 112, the signal indicating the user's presence at the RFID reader 106, and may also transmit another signal instructing the base station 115 to refrain from entering a log entry indicating the user's presence at the sub-space associated with the transmitting RFID reader 106. In response to the signal transmitted by the RFID reader 106, the base station 115 may refrain from adding a log entry in a user (e.g., administrator), accessible log. In one variant, the base station 115 may, e.g., temporarily, record the user's presence at the sub-space for use by the base station 115, as described herein, but may refrain from adding an entry in a user accessible log.

In an alternative example embodiment of the present invention, the user may transmit the log-inhibiting instruction directly to the network of wireless nodes 107 for transmission to the base station 115, via communication path 114. The instruction may be transmitted via an input device of the badge 101, e.g., by pressing a button 103. Alternatively, or in addition, the RFID readers 106 may include buttons for input of the log-inhibiting instruction for direct transmission to the base station 115 via communication path 112. When the base station 115 receives the logging signal from the RFID reader 106, the base station 115 may refrain from inserting a log entry into an accessible log tracking users' movements in the workspace 100.

According to the embodiments that provide for the transmission of log-inhibiting instructions to the base station 115, in response to receipt of a log-inhibiting instruction, the base station 115 may transmit an acknowledgement message indicating success of the command to the user via communication path 114. The message may be transmitted directly to the user's badge 101 or indirectly, via multiple hops through the network of wireless nodes 107. For example, a message may be a printed message, an audible message, and/or a turning on of one or more LEDs of the badge 101.

In one example embodiment of the present invention, a user may transmit an instruction to refrain from logging the presence of all or particular users other than the user, e.g., besides for the user. In one example embodiment, different users may have different authorities. For example, a first user may have no logging restriction authority, a second user may have such authority only with respect to logging of the second user, and a third user may have such authority even with respect to all or particular other users.

In one example embodiment, the log-inhibiting instruction may be a global instruction. In an alternative example embodiment, the instruction may be RFID reader specific. For example, according to the embodiment in which the user transmits the log-inhibiting instruction to the network of wireless nodes 107 via communication path 114, the instruction may be associated with the RFID reader 106 from which the base station 115 approximately concurrently receives a tracking signal associated with the user. In an alternative example embodiment, the instruction may be sub-space specific. In yet another example embodiment, the user may enter different log-inhibiting instructions. One may be a global instruction, another may be RFID reader specific, and yet another may be sub-space specific. For example, for a global or a sub-space specific instruction, the RFID reader 106 may transmit a log-inhibiting instruction to the base station 115 indicating that the base station 115 should not enter a log entry for any log signal, e.g., associated with the user who entered the instruction, that is received from any RFID reader 106 in the workspace 100 (if it is a global instruction) or from any RFID reader 106 in the particular sub-space (if it is a sub-space specific instruction).

Regarding sub-space specific instructions, a first RFID reader 106 may be associated with a large sub-space that is further divided into smaller sub-spaces that are each associated with another RFID reader 106, besides for their association with the first RFID reader 106. For example, sub-spaces 1 and 2 may be rooms within a wing of the workspace 100. The first RFID reader may be associated with the wing and RFID readers 106a-b may be associated with particular rooms of the wing. In one variant, an RFID reader 106 associated with a first sub-space may also be associated with a larger sub-space in which the first sub-space is located. An instruction transmitted to the RFID reader 106 may be associated with the entire larger sub-space. Alternatively, it may be associated with only the smaller sub-space. Alternatively, different instructions may be entered by the user, one associated with the entire larger sub-space, and another associated with the more local sub-space.

In an example embodiment of the present invention, a user may transmit to an RFID reader 106 an instruction along communication path 110 to turn off surveillance equipment, e.g., located in the sub-space with which the RFID reader 106 is associated. The surveillance equipment may be of any suitably appropriate type, e.g., audio/video equipment. For example, the workspace 100 may, include a camera network 108 including video cameras 109 distributed throughout the workspace 100. For example, one or more cameras 109 may be located in a sub-space. The instruction may be entered, for example, by pressing a button 103 of the user's badge 101. Alternatively or in addition, the RFID readers 106 may include buttons for input of the surveillance-inhibiting instructions by the users. In response to receiving the instruction, the RFID reader 106 may transmit, along communication path 112, a signal instructing the base station 115 to communicate with the camera network 108 via communication path 116 to turn off the cameras 109 of the sub-space with which the RFID reader 106 is associated. In response to the signal transmitted by the RFID reader 106, the base station 115 may turn off the cameras 109 of the indicated sub-space.

In an alternative example embodiment of the present invention, the user may transmit the surveillance-inhibiting instruction directly to the network of wireless nodes 107 for transmission to the base station 115, via communication path 114. When the base station 115 receives the logging signal from the RFID reader 106, the base station 115 may turn off the cameras associated with the sub-space with which the RFID reader 106 is associated.

In one example embodiment, the surveillance-inhibiting instruction may be a global instruction. In an alternative example embodiment, the instruction may be RFID reader specific. For example, according to the embodiment in which the user transmits the surveillance-inhibiting instruction to the network of wireless nodes 107 via communication path 114, the instruction may be associated with the RFID reader 106 from which the base station 115 approximately concurrently receives a tracking signal associated with the user. In an alternative example embodiment, the instruction may be sub-space specific. In yet another example embodiment, the user may enter different surveillance-inhibiting instructions. One may be a global instruction, another may be RFID reader specific, and yet another may be sub-space specific. For example, for a global or a sub-space specific instruction, the RFID reader 106 may transmit a surveillance-inhibiting instruction to the base station 115 indicating that the base station 115 should turn off the cameras 109 in the workspace 100 (if it is a global instruction) or in the indicated sub-space (if it is a sub-space specific instruction). For example, if a sub-space specific instruction is received from the RFID reader 106a, or in conjunction with receipt of a tracking signal from the RFID signal 106a, the base station 115 may turn off the camera 109a of sub-space 1, which is associated with the RFID 106a.

In response to receipt of a surveillance-inhibiting instruction, the base station 115 may transmit an acknowledgement message indicating success of the command to the user via communication path 114. The message may be transmitted directly to the user's badge 101 or indirectly, via multiple hops through the network of wireless nodes 107. For example, a message may be a printed message, an audible message, and/or a turning on of one or more LEDs of the badge 101.

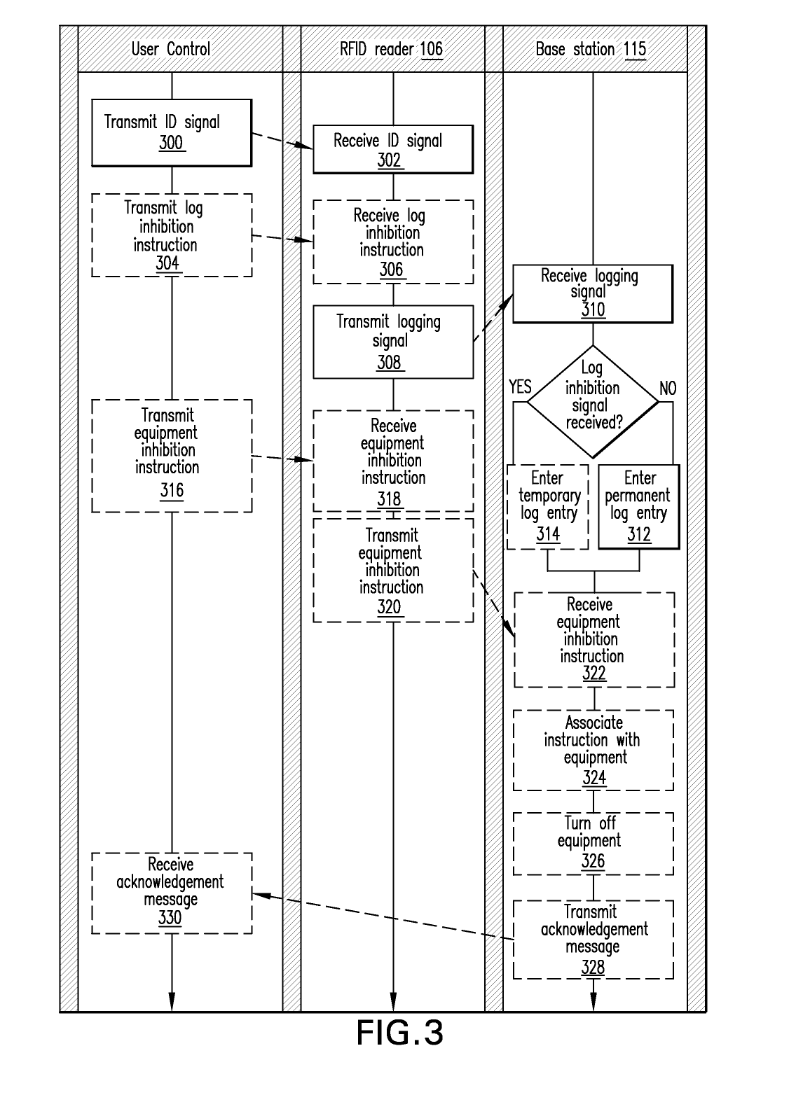

FIG. 3 is a cross-functional flowchart illustrating a method for controlling logging and surveillance in a workspace via an RFID reader, according to an example embodiment of the present invention. In FIG. 3, steps related to inhibition instructions are represented by boxes with dashed borders. Other steps are represented by boxes with solid borders. At step (300), a user may transmit an identification signal to the RFID reader 106. The signal may be transmitted by the RFID tag 102 when it is in close proximity to the RFID reader 106. At step (302), the RFID reader 106 may receive the identification signal. If the RFID reader 106 does not receive any further signal from the user's badge 101, for example, within a predetermined amount of time, the RFID reader 106 may, at step (308), transmit a logging signal that includes the received identification signal to the base station 115.

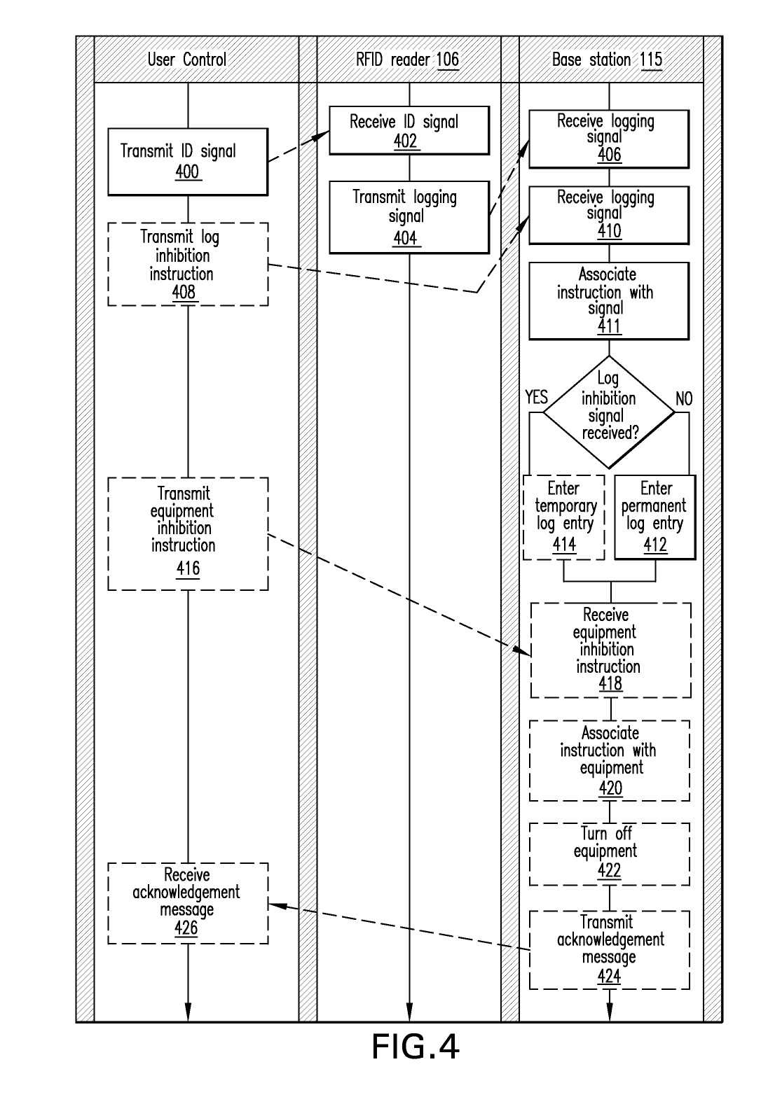

The user may operate a user control, e.g., a button 103, to transmit, at step (304), a log inhibition instruction to the RFID reader 106, which the RFID reader 106 may receive at step (306). If the RFID reader 106 receives a log inhibition instruction, the RFID reader 106 may generate a logging signal that includes the received identification signal with data indicating that the signal should be only temporarily logged. The modified signal may be transmitted by the RFID reader 106 at step (308). In one alternative example embodiment, the RFID reader 106 may initially transmit the logging signal in response to receiving the ID signal, without indicating that the presence of the user should not be logged. Then, if the RFID reader 106 subsequently receives the log inhibition instruction, the RFID reader 106 may subsequently send this instruction, which may be matched by the base station 115 with the previously received ID signal as described below with respect to FIG. 4. The association by the base station 112 may be between a log inhibition instruction received from an RFID reader 106 and an immediately preceding logging signal received from the same RFID reader 106. Alternatively, the log inhibition instruction may identify the ID of the user transmitting the signal. According to this embodiment, the RFID reader 106 may transmit the logging signal immediately in response to receipt of the ID signal, without waiting a predetermined amount of time.

For transmission of the log inhibition instruction to the RFID reader 106, a user may operate a control of the mobile badge 101. Alternatively, the user may input the log inhibition instruction to the RFID reader 106 via the input device of the RFID reader 106. If the instruction is input via the input device of the RFID reader 106, it may be required for the user to enter the user's ID, since the RFID reader 106 may receive a plurality of ID signals from different mobile badges 101 within a short period of time. In one example embodiment, the RFID reader 106 may by default associate the log inhibition instruction with a last ID signal received prior to input of the inhibition instruction. According to one variant of this embodiment, the user may input ID information along with the instruction to override the default association, so as to ensure that the instruction is associated with the correct user.

At step (310), the base station 115 may receive the logging signal transmitted by the RFID reader 106. If the received signal does not include a log inhibition instruction, the base station 115 may (at step (312)), enter a permanent log entry of the user's presence at the RFID reader's location. Otherwise, the base station 115 may (at step (314)), enter a temporary log entry. The temporary log entry may be stored, e.g., for associating a surveillance equipment inhibition instruction, if any, with the temporarily logged user and/or for transmitting an acknowledgement message to the user. According to the embodiment in which the base station 115 may initially receive a logging signal and then separately receive a log inhibition instruction, the base station may initially enter a logging entry, but then discontinue its storage, i.e., delete it, when it receives the inhibition instruction, and may store the temporary log entry in its place. Alternatively, the base station may mark the previously entered entry as temporary.

At step (328), the base station 115 may transmit to the user an acknowledgement message, acknowledging success of the log inhibition instruction. The user may receive the acknowledgement message at step (330).

The user may additionally operate a user control, e.g., a button 103, to transmit, at step (316), a surveillance equipment inhibition signal to the RFID reader 106, which the RFID reader 106 may receive at step (318). The RFID reader 106 may, at step (320), forward the surveillance equipment inhibition instruction to the base station 115, which may receive the instruction at step (322). At step (324), the base station 115 may associate the equipment inhibition instruction with equipment of a particular location. The association may be based on the particular RFID reader 106 from which the base station 115 received the instruction and/or based on content of the instruction. For example, if the message is limited to the particular sub-space at which the RFID reader 106 is located, the base station 115 may associate the instruction with the surveillance equipment of the sub-space of the RFID reader 106 from which the base station 115 received the instruction. If the instruction includes content indicating a more global space, e.g., an entire wing of a building, the base station 115 may associate the instruction with all surveillance equipment in the wing that includes the sub-space at which the RFID reader 106, from which the instruction was received, is located.

For transmission of the surveillance equipment inhibition instruction to the RFID reader 106, a user may operate a control of the mobile badge 101. Alternatively, the user may input the surveillance equipment inhibition instruction to the RFID reader 106 via the input device of the RFID reader 106. The matching of the equipment inhibition instruction with the correct ID signal may be performed as described above with respect to the log inhibition signal.

At step (326), the base station 115 may turn off the relevant surveillance equipment. At step (328), the base station 115 may transmit to the user an acknowledgement message to indicate success of the equipment inhibition instruction. At step (330), the user may receive the acknowledgement message.

FIG. 4 is a cross-functional flowchart illustrating a method for controlling logging and surveillance in a workspace, according to an alternative example embodiment of the present invention. In FIG. 4, steps related to inhibition instructions are represented by boxes with dashed borders. Other steps are represented by boxes with solid borders. At step (400), a user may transmit an identification signal to the RFID reader 106. The signal may be transmitted by the RFID tag 102 when it is in close proximity to the RFID reader 106. At step (402), the RFID reader 106 may receive the identification signal. The RFID reader 106 may, at step (404), transmit a logging signal which includes the received identification signal or some equivalent thereof to the base station 115. The base station 115 may, at step (406), receive the logging signal. If the base station 115 does not receive any further signal associated with the logging signal, e.g., within a predetermined amount of time, the base station 115 may, at step (412), enter a permanent log of presence of the user associated with the ID signal at the location associated with the RFID reader 106.

The user may operate a user control, e.g., a button 103, to transmit, at step (408), a log inhibition instruction directly to the base station 115, which may receive the instruction at step (410). For example, the RFID reader 106 may be one with limited processing capabilities, e.g., limited to receiving an ID signal and forwarding it to the base station 115. At step (411), the base station 115 may associate the log inhibition instruction with the logging signal associated with the ID of the user who has transmitted the log inhibition instruction.

In one example embodiment, the user may input the log inhibition instruction directly to the base station 115 via the input device at the RFID reader 106. According to this embodiment, instead of the RFID reader 106 determining the association between the instruction and the ID signal, as described above with respect to the method illustrated in FIG. 3, the base station 115 may associate the instruction with the previously received ID signal. The association may be based on matching the RFID reader 106 from which the ID signal was received and the RFID reader 106 that includes the input device via which the instruction was entered. By default, the base station may associate the log inhibition instruction with the last ID signal received from the same RFID reader 106 prior to receiving the log inhibition instruction. In one example embodiment, the user may input the user's ID so that the inhibition instruction is correctly associated with the user, rather than with another user whose presence was also detected by the RFID reader 106. If the user enters the ID, the ID match may be sufficient without matching of the RFID reader 106.

If the log inhibition instruction is received, the base station 115 may (at step (414)), enter a temporary log entry, which may be stored, e.g., for associating a surveillance equipment inhibition instruction, if any, with the temporarily logged user and/or for transmitting an acknowledgement message to the user. Alternatively, the base station 115 may initially enter the permanent log, and if the log inhibition signal is subsequently received from the logged user, then the base station 115 may discontinue storing the permanent log, i.e., delete the permanent log, and store a temporary one its place. Alternatively, the base station 115 may mark the log for deletion.

At step (424), the base station 115 may transmit to the user an acknowledgement message, acknowledging success of the log inhibiting instruction. The user may receive the acknowledgement message at step (426).

The user may additionally operate a user control, e.g., a button 103, to transmit, at step (416), a surveillance equipment inhibition instruction directly to the base station 115, which may receive the instruction at step (418). Although steps (408)-(410) and (416)-(418) are illustrated in FIG. 4 as occurring subsequent to steps (400)-(406), the reverse may occur. For example, the user may input an instruction which the mobile badge 101 may transmit to the base station 115 prior to detection of the badge 101 by the RFID reader 106. In this instance, the transmitted inhibition instructions may be queued until location information is later received at step (406).

At step (420), the base station 115 may associate the equipment inhibition instruction with equipment of a particular location. The association may be based on the particular RFID reader 106 from which the base station 115 received a logging signal associated with the user from which the base station 115 received the equipment inhibition instruction and/or based on content of the instruction. For example, if the instruction is limited to the particular sub-space at which the RFID reader 106 is located, the base station 115 may associate the instruction with the surveillance equipment of the sub-space of the RFID reader 106 from which the base station 115 received the logging signal. If the instruction includes content indicating a more global space, e.g., an entire wing of a building, the base station 115 may associate the instruction with all surveillance equipment in the wing that includes the sub-space at which the RFID reader 106, from which the logging signal was received, is located.

In one example embodiment, the user may input the surveillance equipment inhibition instruction directly to the base station 115 via the input device at the RFID reader 106. According to this embodiment, instead of the RFID reader determining the association between the instruction and the ID signal, as described above with respect to the method illustrated in FIG. 3, the base station 115 may associate the instruction with the previously received ID signal. The association may be based on matching the RFID reader 106 from which the ID signal was received and the RFID reader 106 that includes the input device via which the instruction was entered. By default, the base station may associate the surveillance equipment inhibition instruction with the last ID signal received from the same RFID reader 106 prior to receiving the surveillance equipment inhibition instruction. In one example embodiment, the user may input the user's ID so that the inhibition instruction is correctly associated with the user, rather than with another user whose presence was also detected by the RFID reader 106. If the user enters the ID, the ID match may be sufficient without matching of the RFID reader 106, except with respect to determining the location at which the equipment should be turned off.

At step (422), the base station 115 may turn off the relevant surveillance equipment. In an alternative example embodiment, the base station 115 may output a request, e.g., to an administrator, to turn off the relevant equipment, instead of actually turning the equipment off. At step (424), the base station 115 may transmit to the user an acknowledgement message to indicate success of the equipment inhibition instruction, which the user may receive at step (426).

In an example embodiment of the present invention, the system may provide for various states, depending on user instructions input via the user's badge 101 or via an input device located at an RFID reader 106 that associates the instruction with the user's badge 101. Example states are where both tracking and surveillance are enabled, which may be a default state; where both tracking and surveillance are disabled, which may, be in response to instructions by a user; and where one of the tracking and surveillance is disabled while the other is enabled, depending on user instruction. In one example embodiment, in response to an instruction to inhibit logging of tracking information, the system may refrain from entering log entries and may also turn off surveillance equipment.

In an example embodiment of the present invention, the system may remain in one of the non-default states for a predetermined amount of time. In one example embodiment, instead of a predetermined amount of time, the system may remain in one of the non-default states for a user-specified amount of time. After timeout, the system may automatically revert to its default state. For example, the base station 115 may reset a clock 117 in response to a user instruction, and may restart tracking and surveillance when the clock 117 times out. In one example embodiment, the user may enter an instruction for changing the state of the system even before the timeout. For example, the instruction may be to re-enter the default state in which tracking and surveillance are enabled.

In an alternative example embodiment, after timeout, the base station 115 may transmit to the badge 101 a reminder to instruct the system to revert back to the default state after timeout. The reminder may be a printed message, an audible message, or a lighting of one or more LEDs. The user may enter an instruction for changing the state of the system at any time. In one example embodiment, if the user changes the state of the system such that one of the tracking and surveillance remains inhibited, the base station 115 may restart the clock 117 in response to the instruction.

In an alternative example embodiment, a state in one sub-space may revert to the default state when an RFID reader 106 in a sub-space other than the one with which the inhibiting instruction is associated senses presence of the user badge 101 with which the inhibiting instruction is associated. For example, if the instruction is not directed globally to the entire workspace 100, but is limited, for example, to sub-space 1, then if RFID reader 106b receives a signal from the badge 101 and, accordingly, sends a tracking signal to the base station 115, the base station 115 may reset the state of sub-space 1 to the default state. If an inhibiting instruction relating to more than one user was entered, the system may revert back to the default state when the base station 115 receives indications that all users with whom the instruction is associated have left the sub-space with which the instruction is associated.

In one example embodiment, when the base station 115 detects that the user has moved to a different sub-space, the base station 115 may cause the first sub-space to revert to the default state and may set the second sub-space to the non-default state that was previously applied to the first sub-space. For example, when the user moves to the second sub-space, surveillance equipment in the first sub-space may be turned on, and surveillance equipment in the second sub-space may be turned off. However, if the initial surveillance inhibiting instruction associated with an RFID reader 106a is for inhibiting recording by surveillance equipment in an area around the RFID reader 106a that includes surveillance equipment located within sub-space 2 or within a similarly defined area drawn about RFID reader 106b, and/or that includes the location at which the RFID reader 106b is positioned, then the surveillance equipment may be left in the turned off state even after detection of the badge 101 at the RFID reader 106b.

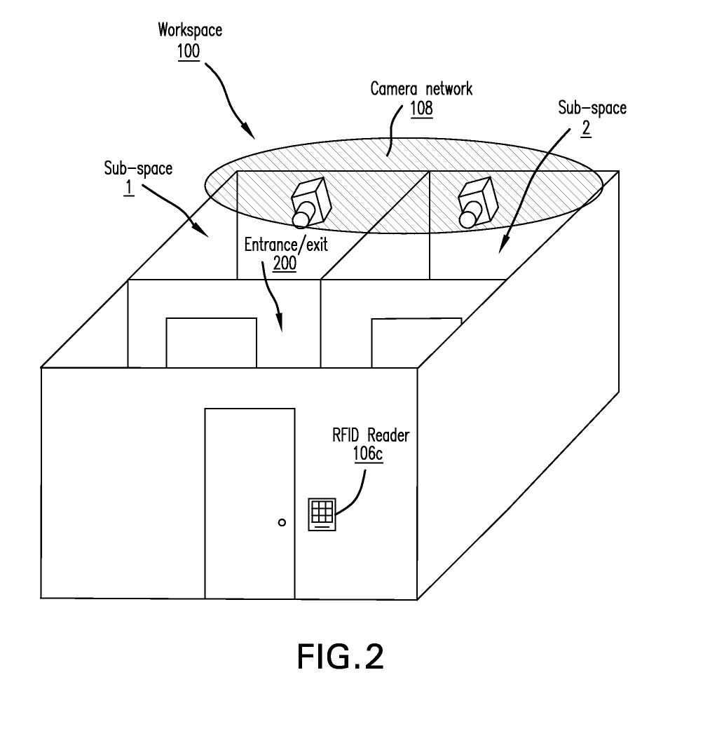

In one variant of the preceding embodiment, RFID readers 106 may be located near one or more entrances/exits of the workspace 100. A rule set according to which the processor 118 of the base station 115 executes user tracking and inhibiting instructions, may provide for non-execution of instructions received from a user approximately, concurrently with receipt of a signal from an RFID reader 106 located at an outer boundary of the workspace 100 indicating the user's presence. For example, referring to FIG. 2, the rule set may provide for non-execution of a user instruction received when the base station 115 receives a signal from the RFID reader 106c indicating the user's presence in the area of the entrance/exit 200. According to this embodiment, even if an executable instruction received from the user is directed to the entire workspace 100, if the base station 115 receives a signal associated with the user from the RFID reader 106c, the base station 115 may cause the default state to be reinstated, since it may be assumed that the user has exited the workspace 100.

In one example embodiment, a combination of two or more of the preceding embodiments may be implemented. For example, the default state may be reinstated if a user instruction for reverting to the default state is received from the user that caused the system to enter a different state; if a first predetermined amount of time elapses; and/or if a signal indicating the user's presence is received from the RFID reader 106c at the entrance/exit 200. Additionally, if a second predetermined amount of time, shorter than the first predetermined amount of time, elapses without satisfaction of any of the conditions for reverting to the default state, the base station 115 may transmit to the user, via communication path 114, a reminder that the system is in the non-default state.

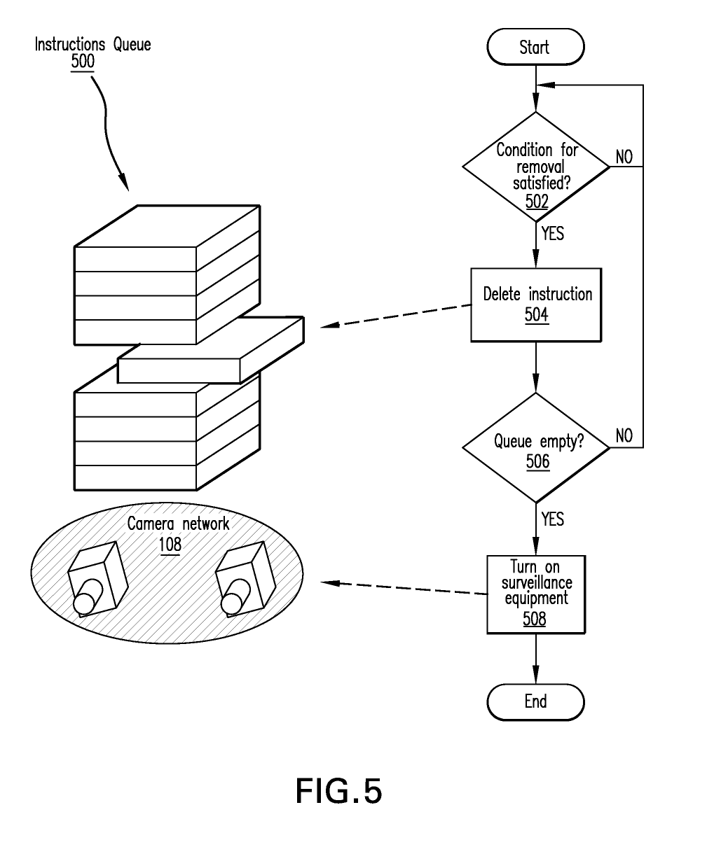

It may occur that two or more users transmit tracking and/or surveillance inhibiting instructions associated with the same sub-space to the base station 115. FIG. 5 is a diagram and flowchart that illustrates an example instructions queuing scheme and method that may be executed for controlling surveillance equipment according to an example embodiment of the present invention. The method may be performed, e.g., by the processor 118 of the base station 115. When the base station 115 receives a surveillance inhibiting instruction, the base station 115 may enter the instruction into an instruction queue 500. If the surveillance equipment of the sub-space(s) with which the instruction is associated is on, the instruction may executed. If it is already turned off, the base station 115 may enter the instruction in an instruction queue 500 without executing the instruction. For determining whether to turn on particular surveillance equipment that has been turned off, e.g., in response to a surveillance inhibiting instruction, the system and method may perform steps (502) to (504).

At step (502), the system and method may determine whether a condition for removal of a surveillance inhibiting instruction is satisfied. For example, receipt of an instruction originating at a badge 101 with which a queued surveillance inhibiting instruction is associated to turn on the surveillance equipment may satisfy a condition for removal of the queued instruction. If no condition for removal of a queued surveillance inhibiting instruction associated with the particular surveillance equipment is satisfied, the system and method may loop back to continue waiting for satisfaction of such a condition.

If a condition for instruction removal is satisfied, an instruction for which the condition is satisfied may be deleted from the queue 500 at step (504). At step (506), it may be determined whether the queue 500 is empty. If it is determined that the queue 500 is not empty, the system and method may loop back to continue waiting for satisfaction of a condition for removal of another surveillance inhibiting instruction. Otherwise, the system and method may, at step (508), turn on the particular surveillance equipment, since no surveillance inhibiting instruction associated with the particular surveillance equipment remains pending in the queue 500.

What is claimed is:

1. A surveillance system, comprising:
a surveillance control unit;
a mobile unit for transmitting an identification signal; and
a first reader unit, statically positioned at a first location, for receiving the identification signal from the mobile unit and for transmitting, in response to receipt of the identification signal, one of the identification signal and another signal that identifies the mobile unit to the surveillance control unit for logging by the surveillance control unit of a presence of the mobile unit at the first location;
wherein at least one of the mobile unit and the first reader unit is configured to transmit at least one surveillance control message for control of surveillance at the first location.

2. The surveillance system of claim 1, further comprising:
surveillance equipment;
wherein the at least one surveillance control message includes at least one of a first instruction type for preventing the logging and a second instruction type for preventing recording by particular ones of the surveillance equipment having an association with the first location.

3. The surveillance system of claim 2, wherein:
the surveillance control unit stores a first log entry indicating the presence of the mobile unit at the first location, the storing being conditional upon receiving the one of the identification signal and the another signal without receiving an instruction of the first instruction type that is associated with the one of the identification signal and the another signal; and
if the surveillance equipment having the association with the first location is on when an instruction of the second instruction type is received by the surveillance control unit, the surveillance control unit turns off the surveillance equipment having the association with the first location in response to receipt of the instruction of the second instruction type.

4. The surveillance system of claim 3, wherein:
the mobile unit transmits the instruction of the first instruction type to the first reader unit;
the first reader unit forwards the instruction of the first instruction type to the surveillance control unit;
responsive to the receipt of the instruction of the first instruction type, the surveillance control unit stores a second log entry of the presence of the mobile unit at the first location, the second log entry being temporary; and
responsive to the receipt of the instruction of the second instruction type, the surveillance control unit associates the instruction of the second instruction type with the first location based on the second log entry.

5. The surveillance system of claim 4, wherein the surveillance control unit initially enters the first log entry, and, for storing the second log entry, the surveillance control unit marks the first log entry as temporary.

6. The surveillance system of claim 3, wherein:
the mobile unit transmits the instruction of the first instruction type to the surveillance control unit;
the surveillance control unit associates the instruction of the first instruction type with the first log entry by determining that the mobile unit identified in the first log entry is the mobile unit from which the instruction of the first instruction type was received; and
responsive to receipt of the instruction of the first instruction type, the surveillance control unit one of discontinues storing the first log entry and refrains from entering the first log entry.

7. The surveillance system of claim 3, wherein, responsive to a lapse, from the turning off of the surveillance equipment having the association with the first location, of one of a predetermined amount of time and an amount of time specified in the instruction of the second instruction type, the surveillance control unit turns on the surveillance equipment having the association with the first location.

8. The surveillance system of claim 3, wherein, subsequent to turning off the surveillance equipment having the association with the first location, the surveillance control unit turns the surveillance equipment having the association with the first location back on in response to a signal that identifies the mobile unit and that is received from a second reader unit statically positioned at a second location if both: (a) the surveillance equipment having the association with the first location does not have an equivalent association with the second location; and (b) the association with the first location does not define an area including the second location.

9. The surveillance system of claim 3, wherein, responsive to a lapse, from the turning off of the surveillance equipment having the association with the first location, of one of a predetermined amount of time and an amount of time specified in the instruction of the second instruction type, the surveillance control unit transmits to the mobile unit a message as a reminder to turn on the surveillance equipment having the association with the first location.

10. The surveillance system of claim 3, wherein:
if the surveillance equipment having the association with the first location is off when the instruction of the second instruction type is received by the surveillance control unit, the surveillance control unit stores the instruction of the second instruction type in an instruction queue for later execution;
the instruction of the second instruction type is removed from the queue in response to at least one of execution of the instruction of the second instruction type, receipt of a trigger originating at the mobile unit for turning on the surveillance equipment having the association with the first location, and a lapse, from a time of receipt of the instruction of the second instruction type by the surveillance control unit, of one of a predetermined amount of time and an amount of time specified in the instruction of the second instruction type;
in response to a trigger for turning on the surveillance equipment having the association with the first location, if any instruction of the second instruction type that is associated with the surveillance equipment having the association with the first location is pending, the surveillance control unit defers turning on the surveillance equipment having the association with the first location until after no instruction of the second instruction type that is associated with the surveillance equipment remains pending; and
a pending instruction is one that is one of queued and being executed.

11. The surveillance system of claim 2, wherein:
the mobile unit transmits the instruction of the first instruction type to the first reader unit; and
responsive to the instruction of the first instruction type, the first reader unit refrains from transmitting the one of the identification signal and another signal to the surveillance control unit.

12. The surveillance system of claim 2, wherein:
the first reader unit includes an input device for receiving input of the at least one surveillance control message;
the first reader unit forwards one of the at least one surveillance control message and a modification of the at least one surveillance control message input via the input device to the surveillance control unit; and
the at least one surveillance control message is associated with the mobile unit based on one of an identification input that is input into the input device, the identification signal, and the another signal.

13. The surveillance system of claim 12, wherein the first reader unit associates the at least one surveillance control message with the mobile unit if the identification signal received by the first reader unit from the mobile unit is one of: (a) an only identification signal received by the first reader unit prior to receiving the input of the at least one surveillance control message; and (b) a last one of a plurality of identification signals that is received by the first reader unit prior to receiving the input of the at least one surveillance control message.

14. The surveillance system of claim 12, wherein the surveillance control unit receives the at least one surveillance control message and associates the at least one surveillance control message with the mobile unit if the one of the identification signal and the another signal received by the surveillance control unit from the first reader unit is one of: (a) an only one of an identification signal and another mobile unit identification signal that is received by the surveillance control unit from the first reader unit; and (b) a last one of a plurality of one of identification signals and other mobile unit identification signals received by the surveillance control unit from the first reader unit prior to receiving the at least one surveillance control message.

15. The surveillance system of claim 2, wherein the surveillance equipment having the association with the first location includes at least one of video and audio surveillance equipment.

16. The surveillance system of claim 15, wherein the at least one of video and audio surveillance equipment includes a video camera.

17. The surveillance system of claim 1, wherein the mobile unit includes a Radio Frequency Identification (RFID) tag for transmitting the identification signal, and the first reader unit includes an RFID reader.

18. A surveillance method, comprising:
transmitting an identification signal by a mobile unit to a reader unit statically positioned at a location for indicating a presence of the mobile unit at the location; and
transmitting at least one surveillance control message by one of the mobile unit and the statically positioned reader unit to a surveillance control unit for at least one of preventing a logging by the surveillance control unit of the presence of the mobile unit at the location and preventing recording by surveillance equipment having an association with the location.

19. The surveillance method of claim 18, further comprising:
for the logging, in response to receiving the identification signal by the reader unit, transmitting, by the reader unit, one of the identification signal and another signal that identifies the mobile unit to the surveillance control unit; and
associating, by the surveillance control unit, the at least one surveillance control message with the one of the identification signal and the another signal by determining that one of:
(a) the mobile unit identified in the one of the identification signal and the another signal is the mobile unit from which the at least one surveillance control message is received; and
(b) the one of the identification signal and the another signal and the at least one surveillance control message are received from the same reader unit, and the one of the identification signal, and the another signal is one of (i) an only one of an identification signal and another mobile unit identification signal received from the reader unit prior to receiving the at least one surveillance control message and (ii) a last one of a plurality of one of identification signals and other mobile unit identification signals received from the reader unit prior to the surveillance control unit receiving the at least one surveillance control message.

20. A mobile identification device, comprising:
an identification signal transmitter for transmitting an identification signal to a reader unit statically located at a location;
an input device for receiving input of at least one surveillance control message; and
a message transmitter for transmitting the at least one surveillance control message to a surveillance control unit for instructing the surveillance control unit to at least one of: (a) refrain from maintaining a log entry indicating a presence of the mobile identification device at the location; and (b) turn off surveillance equipment associated with the location.

21. The mobile identification device of claim 20, wherein the identification signal transmitter is a Radio Frequency Identification (RFID) tag.

22. The mobile identification device of claim 21, wherein the identification signal transmitter and the message transmitter transmit data at different frequencies.

23. The mobile identification device of claim 22, wherein the identification signal transmitter transmits the identification signal at an ultra high frequency.

24. The mobile identification device of claim 23, wherein the message transmitter transmits the at least one surveillance control message at a lower frequency than the ultra high frequency.

25. The mobile identification device of claim 20, wherein the at least one surveillance control message is transmitted for association by the surveillance control unit with one of the identification signal and another signal generated based on the identification signal after receipt of the one of the identification signal and the another signal from the reader unit.

26. The mobile identification device of claim 25, wherein the at least one surveillance control message is associated with the location based on the association of the at least one surveillance control message with the one of the identification signal and the another signal.
